(19) United States
(12) Patent Application Publication
(10) Pub. No.: US 2026/0112025 A1
(43) Pub. Date: Apr. 23, 2026

(54) IMAGE DATA PROCESSING APPARATUS AND METHOD

(71) Applicant: CANON MEDICAL SYSTEMS CORPORATION, Otawara-shi (JP)

(72) Inventors: Donald-bane STEWART, Edinburgh (GB); Jill STEEL, Edinburgh (GB); Donna HOLDCROFT, Edinburgh (GB)

(73) Assignee: CANON MEDICAL SYSTEMS CORPORATION, Otawara-shi (JP)

(21) Appl. No.: 18/918,176

(22) Filed: Oct. 17, 2024

(51) Int. Cl. G06T 7/00; G06T 7/20; G06T 7/50; G06T 7/62; G06V 10/44

(52) U.S. Cl. CPC G06T 7/0012; G06T 7/20; G06T 7/50; G06T 7/62; G06V 10/44; G06T 2207/10132; G06T 2207/30056; G06T 2207/30096; G06T 2207/30101

(57) ABSTRACT

An ultrasound apparatus comprises:
processing circuitry configured to
receive ultrasound data from an ultrasound transducer, wherein the ultrasound transducert is for moving across a region of a patient or other subject to locate a target feature;
generate a sequence of images from the ultrasound data, each image representing a view of the subject at a respective position of the transducer; and
determine differences between images in the sequence and use the differences to determine a part of the sequence that corresponds to a sweep motion by the transducer and a part of the sequence that corresponds to a measurement motion by the transducer.

### FIELD

Embodiments described herein relate generally to a method and apparatus for processing image data.

### BACKGROUND

Liver lesion scanning may be performed by an ultrasound operator sweeping a subject's abdomen, noting the size and location of lesions. To determine the location of the lesion, the operator searches for and identifies relevant surrounding anatomical landmarks of the liver, which requires considerable skill and time.

Liver lesion scanning is performed to either detect previously unknown metastases and/or as part of a process to track previously known metastases. Liver lesion scanning is undertaken visually by an ultrasound (UL) operator, typically using an ultrasound transducer to scan the subject's abdomen from left-to-right or right-to-left, using a 2D imaging technique (B-mode).

FIG. 1 is an illustration of the Couinaud classification of liver segments. Where lesions are detected during scanning, they are typically measured using an elliptical model requiring two measurements per lesion and their location is recorded. The location comprises one of eight potential liver segments as defined by the Couinaud classification. These segments are defined as areas of the liver that are bounded by the major vessels in the liver. Three major vessels of the liver (the right hepatic vein 12, the middle hepatic vein 14 and the left hepatic vein 16) are shown in FIG. 1.

FIG. 2 is a schematic illustration of the steps performed to scan or sweep the liver to determine the presence and location of a liver lesion in a clinical setting by a human operator according to known techniques. In step 202, an ultrasound operator linearly scans the subject's abdomen with an ultrasound transducer 214. When a lesion is visually identified by the operator, the ultrasound transducer 214 is centered on the lesion in step 204 in a manual process by the human operator. In step 206, the ultrasound transducer 214 may be rotated by the human operator to measure lesion dimensions, for example to measure the largest dimension of the lesion made visible during the rotation of the transducer. The size of the lesion is visually determined and recorded by the human operator. In step 208, the operator then searches for anatomy in the vicinity of the lesion in order to identify the liver segment that comprises the lesion. This can be a particularly time-consuming task and requires skill and knowledge from the human operator. Once enough anatomy has been identified by the human operator, a liver segment is assigned to the lesion and in step 210, the transducer is then returned to the last position it was in during the sweep phase. This may be the location where the lesion was first detected. In step 212, the transducer sweep is then resumed.

The process described above requires considerable skill in manipulating the position and orientation of the ultrasound transducer 214 to scan the vicinity of the lesion. These movements, in addition to the sweep of the transducer during the scan are time consuming and physically stressful and have potential for incurring musculoskeletal damage to the human operator. The process also requires considerable cognitive skill in identifying the liver segments in the scan and the particular segment comprising the lesion.

As described above, significant time, effort and skill are required on the part of the human operator to identify the correct liver segment, return to the lesion position and continue the sweep. A lengthy diagnostic process reduces the potential throughput of a hospital or clinical establishment. The human skill required to identify liver segments is typically greater than the skill required to identify and measure lesions.

### BRIEF DESCRIPTION OF THE DRAWINGS

Embodiments and examples are now described, by way of non-limiting example, and are illustrated in the following figures, in which:

FIG. 1 is an illustration of the Couinaud classification of liver segments;

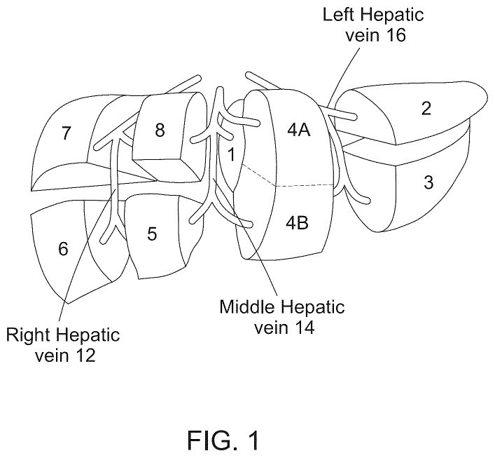

FIG. 2 is a schematic illustration of steps performed to scan a liver in a clinical setting;

FIG. 3 is a schematic illustration of an apparatus in accordance with an embodiment;

FIG. 4 is a flow chart illustrating a method of processing ultrasound images in accordance with an embodiment;

FIG. 5 shows five drawings illustrating images obtained from a scan and the effects of transducer movements; and

FIG. 6 is a flow chart illustrating a method of processing ultrasound images in accordance with an embodiment.

### DETAILED DESCRIPTION

According to certain embodiments there is provided an ultrasound apparatus comprising processing circuitry configured to:
receive ultrasound data from an ultrasound transducer, wherein the ultrasound transducer is for moving across a region of a patient or other subject to locate a target feature;
generate a sequence of images from the ultrasound data, each image representing a view of the subject at a respective position of the transducer; and
determine differences between images in the sequence and use the differences to determine a part of the sequence that corresponds to a sweep motion by the transducer and a part of the sequence that corresponds to a measurement motion by the transducer. The measurement motion may be for determining a location of the target feature and/or measuring the target feature.

According to certain embodiments there is provided an ultrasound method comprising:
receiving ultrasound data from an ultrasound transducer moving or moved across a region of a patient or other subject to locate a target feature;
generating a sequence of images from the ultrasound data, each image representing a view of the subject at a respective position of the transducer;
determining differences between images in the sequence;
using the differences to determine a part of the sequence that corresponds to a sweep motion by the transducer and a part of the sequence that corresponds to a measurement motion by the transducer. The measurement motion may be for determining a location of the target feature and/or measuring the target feature.

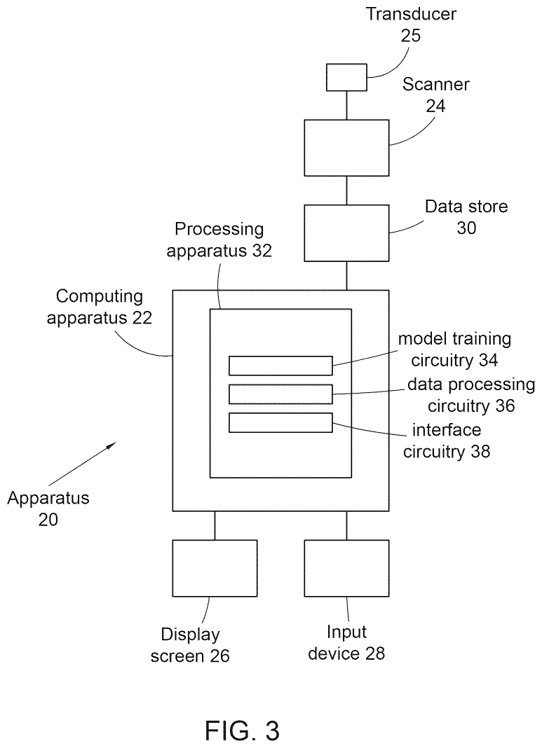

A data processing apparatus 20 according to an embodiment is illustrated schematically in FIG. 3. In the present embodiment, the data processing apparatus 20 is configured to process medical image data. In other embodiments, the data processing apparatus 20 may be configured to process any other appropriate image data.

The data processing apparatus 20 comprises a computing apparatus 22, which in this case is a personal computer (PC) or workstation. The computing apparatus 22 is connected to a display screen 26 or other display device, and an input device or devices 28, such as a computer keyboard and mouse.

The computing apparatus 22 is configured to obtain data sets from a data store 30. At least some of the data obtained from the data store comprises medical imaging data, for instance data obtained using an ultrasound scanner 24. The medical image data comprises two-, three- or four-dimensional ultrasound data. The scanner 24 comprises an ultrasound scanner system that includes an ultrasound transducer 25. Any suitable ultrasound scanner system may be used which includes an ultrasound transducer for moving across a region of a patient or other subject thereby to obtain ultrasound data that can be used to generate a sequence of images from the ultrasound data, each image representing a view of the subject at a respective position of the transducer. Examples of suitable ultrasound scanner systems include, but are not limited to, the Canon Aplio i700, i800 and i900, the Canon Aplio Flex, the Canon Aplio Go.

The computing apparatus 22 may receive data from one or more further data stores (not shown) instead of or in addition to data store 30. For example, the computing apparatus 22 may receive medical image data from one or more remote data stores (not shown) which may form part of a Picture Archiving and Communication System (PACS) or other information system.

Computing apparatus 22 provides a processing resource for automatically or semi-automatically processing the data. Computing apparatus 22 comprises a processing apparatus 32. The processing apparatus 32 comprises optional model training circuitry 34 configured to train one or more models, data processing circuitry 36 configured to apply trained model(s) and to perform other processes according to embodiments, and interface circuitry 38 configured to obtain user or other inputs and/or to output results of the data processing.

The data processing circuitry may be configured to apply one or more algorithms, for example sweep position algorithm, registration algorithm, liver-plane detection algorithm, measurement-movement algorithm, a lesion or other target position algorithm.

Any suitable trained model may be used in some embodiments, for example a convolutional neural network (CNN) or other neural network, or a transformer architecture. In the case of a neural network, any suitable number of nodes at input, output and hidden layers, and any suitable number and arrangement of layers may be used. Any suitable loss functions, activation function, pooling or unpooling layers, or other model features may be used. The trained model may be used to provide the functionality of any of the algorithms mentioned herein, alone or in combination. The model may be trained in a supervised, semi-supervised, or unsupervised fashion. The model may be trained on annotated ultrasound image data, for example including labels for lesions, liver planes and/or Couinaud or other regions. The annotations may for example be provided by human experts.

In alternative embodiments, a trained machine learning model is not used and instead the algorithms and/or other processes are implemented using any suitable known non-machine learning computer programing techniques.

In the present embodiment, the circuitries 34, 36, 38 are each implemented in computing apparatus 22 by means of a computer program having computer-readable instructions that are executable to perform the method of the embodiment. However, in other embodiments, the various circuitries may be implemented as one or more ASICs (application specific integrated circuits) or FPGAs (field programmable gate arrays). In other embodiments, distributed processing may be provided with at least some of the processing provided in different locations or in different apparatus, for example in a networked or cloud computing system.

The computing apparatus 22 also includes a hard drive and other components of a PC including RAM, ROM, a data bus, an operating system including various device drivers, and hardware devices including a graphics card. Such components are not shown in FIG. 3 for clarity.

The data processing apparatus 20 of FIG. 3 is configured to perform methods as illustrated and/or described in the following.

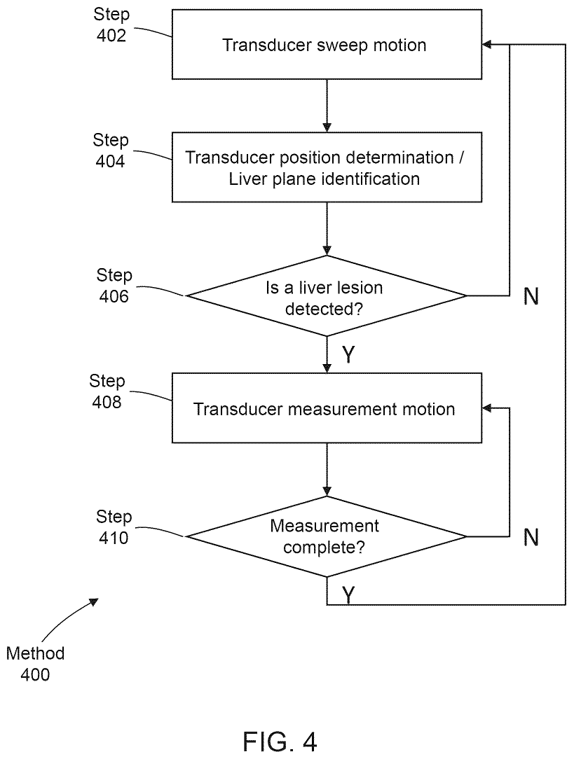

FIG. 4 is a schematic diagram of a method 400 of processing ultrasound images to identify and measure lesions or other target features and determine the location of lesions in the liver or other target feature in accordance with an embodiment.

In step 402, the operator begins an ultrasound scan by sweeping the ultrasound transducer 25 across the abdomen of the patient or other subject and collecting ultrasound data received from the transducer. The transducer is considered to be performing a sweep motion during this part of the method. The sweep motion may be performed for a variety of reasons but is usually performed to search for a target feature of interest, for example a lesion or other pathology.

The sweep motion comprises motion of the ultrasound transducer 25 on the surface of the subject. The ultrasound transducer is usually in contact with the surface of the subject during this motion. Sweep motion typically follows a line or a curve that corresponds with the surface of the subject. The sweep motion may in some examples include a curved motion that, for example, follows the contours of the surface of the patient. When the transducer 25 follows a straight line, there is no tilting of the transducer. However, when following a curved section of the surface of the subject, an axis of the transducer may tilt with respect to a Cartesian co-ordinate system. For instance, it can be understood that an axis that is perpendicular to a measurement surface of the transducer would tilt when considered in Cartesian co-ordinate system as the transducer sweeps across a curved surface of the subject, and would remain constant as the transducer sweeps across a flat surface of the subject. This is distinguished from a measurement motion which is described subsequently and may, for example, comprise a significant rotational motion of the transducer. The nature of the rotational motion during a measurement motion, for example the amount or direction of rotation or other properties of the rotational motion, may make it easy distinguish from a gradual tilting that may occur as the transducer is swept over a curved surface of the subject.

As a general point, for ultrasound to obtain an image from inside a subject, the transducer will usually stay in contact with the surface of the subject. Thus the transducer will not move towards/away from the subject-unless the user wants to reposition the transducer during the procedure (for example, they may do that to get back to a sweep position after locating the liver region for a discovered lesion. Generally, but not necessarily, the user keeps the transducer on the subject through the whole procedure. Sweep movement is thus on the surface of the subject and usually follows a simple linear or curved path. The image seen during a sweep changes according to changes in the anatomy under the transducer along that path. Translation of the transducer to a lesion position may be considered as a motion with the task of centering or otherwise positioning a feature currently visible e.g. on a 2D view. The translation of the transducer to center a feature of interest on a view will also usually be performed whilst keeping the transducer in contact with the surface of the subject. Usually only measurement motion, discussed further below in relation to step 408, has a significant rotation component. The sweep motion does not usually include significant rotation motion, and often any translation motion to centre a feature of interest, e.g. target, on the image displayed to user, for example prior to measurement motion, also does not include significant rotation. Once the start of measurement motion has been determined, prior images may be analysed to see where translation motion started e.g. where there was a transition from a sweep motion to a translation motion to centre a feature of interest.

The scan may be a subcostal scan. References to the ultrasound transducer being in contact with the subject include situations where a gel or other substance is provided between the transducer and the surface of the subject, in accordance with known ultrasound techniques. In other embodiments, a variety of other movements of the ultrasound transducer 25 may be used to scan the subject.

The ultrasound transducer 25 scans the subject in a specified direction and obtains ultrasound data which is used by the processing apparatus 32 to generate a sequence of ultrasound images of the subject's anatomy. The ultrasound image obtained from the transducer at a selected time under consideration may be referred to as a current image. Ultrasound images obtained from the transducer during sweep movement can be referred to as sweep images to differentiate them from measurement images, discussed later.

The interface circuitry 38, processing circuitry 36 and display device 26 co-operate in order to display an operator interface to the operator on the display device 26. Any suitable operator interface may be provided and for example may include a window for displaying current images generated during the scan and the ability to annotate, highlight, zoom in on otherwise vary the appearance of particular features of interest or particular images, for example a target feature. The operator interface may also be used to display control parameters or measurement parameters and to provide workflow instructions or descriptions. Any suitable format and functionality of operator interface may be provided. For example any suitable known operator interface features and functionalities may be included.

A workflow may be chosen by the operator that defines the sweep direction as either left-to-right or right-to left. In other embodiments, the defining of the sweep direction may be automated. The ultrasound images obtained during sweep motion are labelled as having been obtained during sweep motion.

It is a feature of embodiments that a sequence of ultrasound images obtained using the transducer can be processed to determine differences between images in the sequence, and in turn those differences can be used to determine parts of the sequence that correspond to different types of motion, for example a sweep motion and a measurement motion for measuring a target feature. It is also a feature of some embodiments that the position of the transducer can be determined automatically by the system, for example by registering the ultrasound images to reference images and, for example, a location (for example a liver segment where the target feature is determined to be present) can be assigned to the target feature which is the subject of the measurement motion. This can reduce the burden on the operator as well as reducing the skill level needed to conduct a scan and to assign a liver segment or other location to a lesion or other target feature.

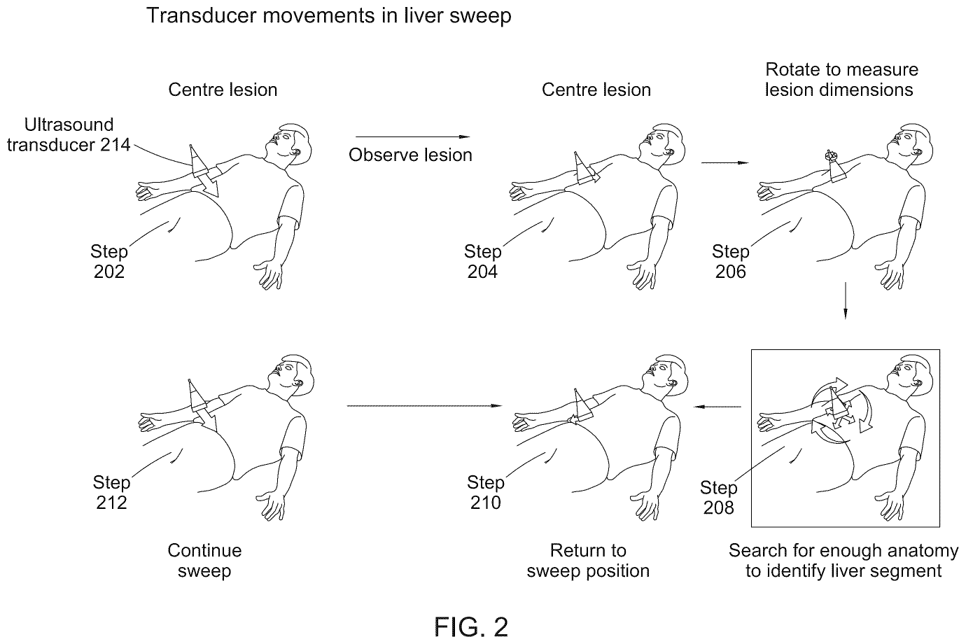

Further detail is now provided concerning the processing of the images to determine different types of motion and to assign a location to a lesion, according to the method illustrated in FIG. 4 using the system of FIG. 2.

At step 404, the position of the transducer is determined for each image in the sequence, or at least some of the images in the sequence. Any suitable co-ordinate system may be used.

The position of the transducer may be determined by matching the images in the sequence to at least one atlas, reference image or other reference data set. The matching may, for example, comprise any suitable rigid or non-rigid registration procedure.

At least one of the images in the sequence may be processed by the processing apparatus 32 to detect anatomical landmarks or anatomical features in the field of view of the transducer. In this way, a position can be assigned to the transducer that is relative to the position of an anatomical landmark. Anatomical landmarks or anatomical features may comprise any feature clearly visible in an ultrasound image such as blood vessels and the profile, or part of the profile, of the liver.

The transducer may be assigned a position relative to one or more anatomical landmarks. In some embodiments, anatomical landmarks may be assigned positions relative to other anatomical landmarks.

Two or more of the images, for example from a sequence of images, may be compared to each other in order to detect relative movement of the transducer between images. The difference between captured images may be detected as the result of a movement of the transducer and be used to detect the displacement and/or the velocity of the transducer. If at least some of the images are registered to at least one atlas, reference image or other reference data set thereby to set transducer position relative to anatomical features for at least some of the images, then transducer position can also be determined for other of the images based on the determined relative movement.

The determined position of the transducer relative to at least one anatomical landmark combined with measured displacement and/or velocity may be used to automatically update the position of the transducer. The position of the transducer determined in this way may be used to correct or adjust positions of the transducer that are determined using comparison of ultrasound images to reference images. In another embodiment, the position of the transducer may be determined relative to at least one anatomical landmark wherein at least some of the obtained ultrasound images are compared with one or more liver images or liver-planes.

Liver-planes or liver images may be used as reference images of the liver and surrounding anatomy. In ultrasound processes, a plane may be considered to comprise or represent an image of a specific anatomy obtained from a specific imaging direction. A liver-plane may be considered to comprise or represent an image of at least a part of the liver taken from a specific direction. In some examples, the set of liver-planes is a set of images of at least part of the liver of a subject, obtained by the ultrasound transducer or other imaging apparatus during a sweep motion on the surface of the subject's abdomen. The images may include blood vessels associated with the liver, branching points of vessels associated with the liver as well as images containing the liver itself. The images may be obtained for different angles of the transducer with respect to the surface of the subject. The images may be obtained from a plurality of subjects to account for anatomical variations in different subjects.

The set of liver-planes may be a sequence of images of the liver and vessels associated with the liver. The order of the sequence of images may be based on the direction of movement of an ultrasound transducer used to obtain the liver-planes. If an image obtained during a scan of the liver is identified as matching a known liver-plane, the location of the ultrasound transducer 25 at the position where the image was obtained can be determined using the liver-plane.

Anatomical variations between subjects may mean there are variations in the plane order and not all planes will exist for all subjects. However, on completion of the sweep, each subject will have a sufficient number and order of planes identified to enable liver segment identification at any point in the sweep. Each liver plane image is annotated with the liver segments visible on that image. Each liver plane can thus be used as an atlas to define liver segments. When a matching liver plane is identified, the processing apparatus 26 records the current position of the ultrasound transducer 25.

The set of liver-planes may be saved in memory such as in the data store 30 and be provided to the sweep position algorithm at the time of scan. In the current embodiment, liver-planes are defined as identifiable anatomical structures in the left-to-right and right-to-left sweep direction with respect to the liver. Liver plane images are used as atlas images such that any position in a matched image may have an equivalent position in the ‘current’ liver-plane image. Once the position of an anatomical feature is identified on both the obtained image and a reference image, each position on the obtained image may be assigned an equivalent position on the reference image. The sequence of plane identifications can be used by the sweep position algorithm to refine its analysis in cases where some planes have similar anatomical structures to others but occur at different parts of the sequence.

When a liver plane is successfully identified and associated with an obtained ultrasound image, it is possible not only to determine the position of the transducer relative to the landmark but it is also possible to determine an equivalent position of the transducer on the reference image. Subsequent movement of the transducer can then be used to determine a new position of the transducer relative to the landmark in addition to or separately from the identification of a liver plane at the new position. There may be a liver plane associated with each ultrasound image or there may be a subset of the obtained ultrasound images with an associated liver plane. More than one ultrasound image may be associated with the same liver plane. In this way, each anatomical feature detected and matched with reference images will have a position assigned to it.

The set of planes used by the algorithm are sufficient to identify the position of the ultrasound transducer within the segments as defined in the Couinaud classification. This requirement is satisfied, for example, by a set of planes that contain major vascular landmarks and/or their branching in space. The set of planes may also include liver edge shapes and the starting and ending points of vessels associated with the liver. Each liver-plane is annotated with the liver segments it contains. Liver-plane images are used as atlas images such that any position in a matched image has an equivalent point in the liver plane image identified. Detection of liver-planes in a known sweep order, such as left to right or right to left, may contribute to the process for identifying a liver segment.

Anatomical variations between subjects may mean there are variations in the plane order and not all planes will exist for all subjects.

The Couinaud segmentation may be non-rigidly deformed to match the anatomy depicted by the obtained ultrasound images before comparing the ultrasound images to the liver planes. The order of identified liver-planes, corresponding to obtained ultrasound images of the subject, can be used to determine the next liver-plane in a sequence of liver-planes. The obtained ultrasound images, when matched with liver-planes, can be used to determine whether the sweep is left-to-right or right-to-left.

Step 404 continues until a possible liver lesion or other target feature is observed. The operator may provide an input to the system that a candidate lesion or other target feature is observed.

Step 406 is invoked when the operator observes a liver lesion in the obtained ultrasound images. If no lesion is detected on further investigation by the operator, the sweep motion of step 402 continues upon the operator's input. If the operator observes a potential lesion during the sweep, the operator must confirm or refute the presence of a lesion. The confirmation of a potential lesion may require additional movement of the ultrasound transducer. If confirmed as a lesion, the operator typically needs to perform further transducer movements to measure the lesion. The potential lesion may also be a false positive and the operator may reject it as a lesion at any point after the initial observation.

Once a lesion is detected in step 406, the transducer enters measurement mode in step 408 in which there is a measurement motion of the transducer. Measurement motion can include or be immediately preceded by a translation motion wherein the transducer is moved to a location assigned to an anatomical feature so that the anatomical feature is disposed in the centre, or other desired position, of the ultrasound image generated by the transducer at the location associated with the anatomical feature. Measurement motion further comprises rotating the ultrasound transducer in order to rotate its imaging plane. This may be done to measure the largest and smallest dimensions of the lesion, or to perform any other desired measurements. The rotational motion following the translational motion during measurement phase may comprise rotating the transducer while keeping the lesion in the imaging plane of the transducer. Identifying where translation preceding measurement-motion starts can be difficult in a purely time-advancing analysis. However, measurement rotation can be easy to detect. Once rotation is observed, we can then backtrack from that point through the preceding images to identify the time point / image where the translation motion started (e.g. the point where the sweep motion was replaced by a translation motion to centre on a feature of interest).

During measurement mode, the processing apparatus 26 may identify the Couinaud segment that comprises the lesion and store one or more associated ultrasound images and/or reference images. The segment can be identified automatically by the processing circuitry as the location of the transducer relative to patient anatomy, for example liver segments. This may be determined automatically by processing of the ultrasound images using the processes of stage 402. The processing apparatus 26 may provide the identified liver segment to the operator whereupon the operator is requested to confirm the liver segment determined or enter a correct liver segment comprising the lesion. There may be a qualifying set of conditions to request the operator's confirmation such as when thresholds are used and/or if the consequent confidence in results is low. In some examples, the liver-plane that follows the liver-plane containing the lesion in the sweep direction of a first scan may be used as a first liver segment. The ultrasound transducer may then be swept in a direction opposite to that of the sweep direction of the first scan. The liver segment classifications using two different scan directions may then be compared. If they do not correspond, then the processing apparatus may consider confidence in the identification of a liver segment low and request the operator's confirmation. The associated ultrasound images and/or reference images may be annotated to identify anatomical features and liver segments according to the Couinaud classification. The images and/or a visual and/or aural indication, or any other suitable indication, of the liver segment may be provided to the operator using the interface circuitry 38.

Once the operator has measured the lesion or rejected it as a false positive identification, in step 410 the operator returns transducer 25 to the sweep position where the potential lesion was first observed and before measurement motion was initiated. Images recorded in the measurement phase are labelled as having been obtained during measurement motion. The operator may be provided with instructions automatically via the operator interface to guide the transducer back to the sweep position immediately before the measurement motion began, so that the sweep may resume from the position where it was interrupted. The instructions may be generated by the system based on the positons of the transducer determined by processing the ultrasound images.

In the process of FIG. 4 the matching of image data to an atlas, reference image(s) or other reference data is performed using a suitable registration algorithm. In other embodiments, the matching of image data to an atlas, reference image(s) or other reference data and/or the determination of location(s) and/or determination of different types of motion may be performed using one or more suitable trained models applied to the ultrasound data and/or images by the processing circuitry 36. The trained machine learning model may process the obtained sequence of images to determine the position of the transducer relative to one or more anatomical landmarks or relative to an operator-chosen reference point in the transducer's imaging plane. In another embodiment, the data processing apparatus 26 may comprise a machine learning model trained on a data set comprising one or more liver images or liver-planes and wherein the model processes the obtained sequence of images to determine the position of the transducer relative to one or more anatomical landmarks or relative to an operator-chosen reference point in the transducer's imaging plane. The trained machine learning model(s) may be trained using optional model training circuitry 34 in some embodiments, or may be trained by a separate apparatus and downloaded to the apparatus 20. In other embodiments the trained machine learning model(s) may be hosted on a remote server and the processing circuitry may transmit, for example over a network or other suitable connection, the data to the trained machine learning model(s) for processing and may then receive the results of the processing.

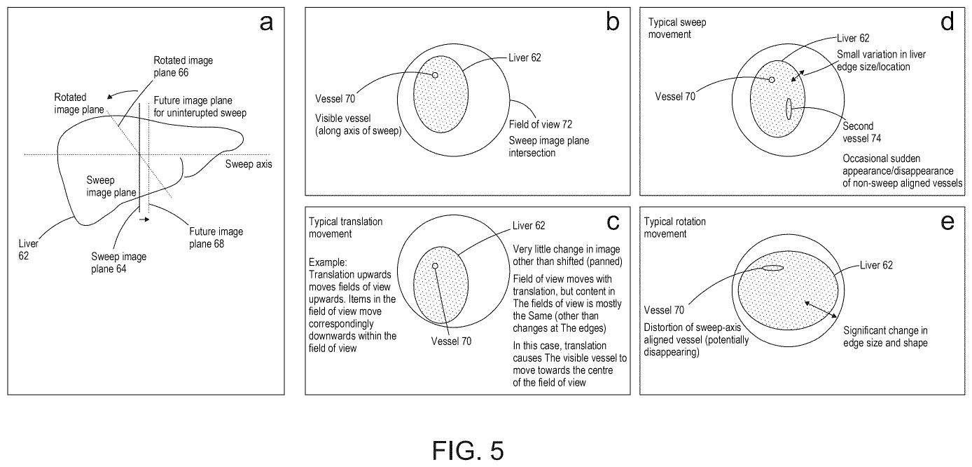

Turning to FIG. 5, further details of measuring a lesion or other target feature in some embodiments are now provided.

When measuring a lesion, the lesion is centred and then the transducer rotated to determine and record the maximum diameter of the lesion. Usually, the user then determines and records the maximum diameter perpendicular to the first measured diameter, these measurements providing an elliptical model of the lesion. The probe is then returned to the sweep position.

FIG. 5 shows five drawings illustrating images obtained from a scan and the effects of transducer movements on the profiles of anatomical landmarks visible in the scan. In this embodiment, vascular landmarks have been described but other landmarks may be used.

FIG. 5a shows the sweep plane and liverb 62 with a sweep image plane 64 illustrated. The sweep image plane is perpendicular to the axis of the transducer view or sweep axis. The image plane is then shown rotated counter clockwise to obtain a rotated image plane 66. A future image plane 68 shows an image plane for a situation where the image plane was not rotated and continued uninterrupted.

FIGS. 5b-5e illustrate how movements of the transducer affect the visual characteristics of the ultrasound images obtained from the transducer. FIG. 5b shows a field of view 72 of the imaging apparatus and a vessel 70 when the transducer is at rest. The vessel 70 is visible in this image because it shares its axis, or nearly shares its axis, with the sweep axis, wherein the sweep axis is perpendicular to the sweep plane. Other vessels in the field of view may not be visible due to a lack of alignment with the sweep axis.

FIG. 5c shows the field of view when the transducer is completing a translation movement. The translation movement may comprise a panning of the image, and may also be referred to as a panning movement. When the transducer is completing a translation movement, new anatomical features may enter the image from the edge of the image and existing anatomical features may leave the image from the edge. Anatomical features already in the center of the image may be moved up or down but will maintain their relative positions. Very little change is perceptible in the shape and size of the vessel and field of view for a translation movement.

FIG. 5d shows the field of view when the transducer is completing a typical sweep movement. When sweeping, new things can enter the image from anywhere (and similarly old things can leave the image from anywhere). The relative position and shapes of items in the image may also change when sweeping. Small variation is visible in the size and/or profile of the vessel 70 for a sweep movement. The visible liver edge changes slowly during sweep motion. The size and position of the field of view experiences similarly small variations. As the sweep progresses, other vessels may become temporarily aligned with the sweep axis and hence temporarily appear in the sequence of images. One of these is labelled as second vessel 74 in FIG. 5d. FIG. 5e shows the field of view when the transducer is completing a rotation movement. The vessel 70 is shown as distorting significantly and potentially disappearing from view. This may be due a misalignment between the vessel axis and the sweep axis during rotation. The size and position of the visible portion of the liver is also shown significantly affected in FIG. 5e.

The initial centering movement of the transducer is dominantly a translation in the current image plane rather than a movement along the left-right liver axis, followed by rotation/small-shifts at/near the new center point.

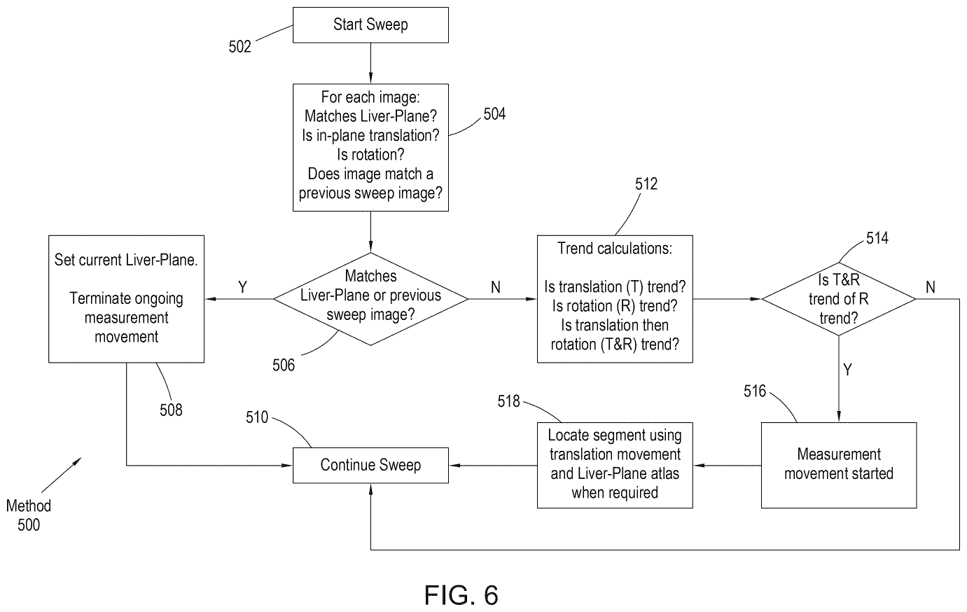

FIG. 6 is a schematic diagram of a method 500 of processing ultrasound images to identify and measure lesions and determine the location of lesions in the liver in accordance with an embodiment.

In step 502, the transducer 25 begins a linear sweep motion over the subject's liver. For each image, in step 504, the processing apparatus 26 determines if the image matches a liver-plane or a previous sweep image.

All images are sweep images except those that occur during measurement movements. The processing apparatus may use a trained machine learning model to determine the presence of a match.

If a match is found between the ‘current image’, for example as discussed in relation to other embodiments, and one or more liver-planes, then the one or more liver planes are labelled as the ‘current liver-plane(s)’ and any ongoing measurement movement is terminated in step 508. This returns the transducer 25 to sweep movement in step 510.

When no liver plane has yet been set then the process is at the start of the sweep, and thus there may be no atlas. At this start stage, regions can be determined using known anatomical information, for example discriminating Couinaud region 6 from region 7, or region 2 from region 3, is fairly simple using for example information concerning the edge of the liver. Alternatively or additionally, once the first liver plane after detection of a lesion is reached, the location of that first liver plane can then be used to set the position of the previously detected lesion.

If no liver-plane or previous sweep image matches the ultrasound image in step 506, step 512 determines whether processing of one or more ultrasound images using the processing apparatus 26 reveals a translation motion, a rotation motion or a combination of a translation motion and a rotation motion.

If processing the sequence of ultrasound images determines that only translation motion is identifiable in in the images, then sweep motion continues in step 510.

If rotation is detected, or if translation followed by rotation is detected, transducer 25 enters measurement motion in step 516. In step 516, the conditions that a trend is defined as a measurement are made. The trend can then be back-tracked to where it started, and those images in the backtracked images defined as measurement movements, not sweep movements. The transducer may be moved to a position where the lesion is centered in the view of the transducer 25.

In step 518, the transducer is moved by the operator to locate the lesion and the segment of the liver that comprises the lesion. Once the lesion has been labelled as a false positive identification or a lesion has been identified and measure, the transducer returns to its last position in sweep motion before measurement motion began, and continues to sweep in step 510.

The procedure at step 518 may be performed once measurement rotation is started. It can also be done retrospectively on the next liver plane detection (either for the case of first regions, or for the case where previous and following liver planes are both used to locate the region. A low-reliability flag can be used in some embodiments if the locations determined using the previous and following liver planes do not agree.

For each liver lesion detected, the sweep position is known from the position at which the transducer transitions from sweep motion to translation motion or measurement motion. The processing apparatus can determine the position of the lesion from the translation used to re-centre the ultrasound image to the lesion in the measurement motion phase. This provides the necessary location information to identify the liver segment of the lesion, for example using annotated reference images.

Further embodiments, or additional alternative features that can be used in conjunction with embodiments above, are now described. The following describes a series of settings that may be chosen/entered by an operator in order to initiate the sweep of the liver using an imaging technology according to an embodiment. The apparatus may communicate with the operator using the interface circuitry 38.
1) define current phase: “sweep” or “measurement”

The phase may also be that of confirming/measuring a lesion once the scan is in progress. In some embodiments the confirming/measuring phase may be entered automatically and in other embodiments, it may be manually initiated.
2) Set current phase direction: user sets direction as either “left-to-right” or “right-to left”.
3) Start image recording: initiates the ultrasound hardware to begin capturing images from the ultrasound transducer.
4) Start liver-plane detection algorithm: the liver-plane detection algorithm compares the current image to a set of potential liver-planes to find a match. The liver-plane algorithm may use a trained machine learning model to compare the image to the liver planes.
5) Start measurement-movement algorithm: the measurement-movement algorithm recognises movement of the ultrasound transducer to measure a lesion as being different to the movement of the ultrasound transducer in an uninterrupted liver sweep. It uses the position of the transducer to assign a position to a lesion and determine an equivalent position on an annotated reference image.
6) Flag current image with current phase: phases may include ‘sweep’ and ‘measurement’ In another embodiment, a plane detection algorithm may use the data from previous plane identifications, sweep directions and/or sweep phase information to modify a-priori probabilities of potential planes. The plane detection algorithm may also modify the probabilities during post-processing, the output probabilities of one or more potential planes may be used to identify the most probable plane or planes. The algorithm may comprise a machine learning model to perform some or all of the processing performed. Such a method may comprise the following steps and criterions:
Step 1: Input current image
Step 2: Input one or more of sweep direction, transducer phase and previous liver-plane identifications.
Criterion 1: When the transducer is in sweep phase with known direction, the a-priori probability of the next plane can be modified by expectation.
Criterion 2: When the transducer transitions from measurement motion phase to sweep motion phase, it may not return exactly to its previous sweep position. This could be due to transducer repositioning error as a result of user error, mechanical factors or otherwise. It is likely in such a case, that the desired sweep position is the previous plane identified, and if not, the next-most-likely-sequence plane to the last plane identified.

In another embodiment, a measurement-movement identification algorithm recognises movement of the ultrasound transducer to measure a lesion as being different to the movement of the ultrasound transducer in an uninterrupted liver sweep. When confirming/measuring a lesion, the potential lesion is centered and then the ultrasound transducer is rotated to measure the lesion. Once the lesion is measured or discarded as a false positive, the transducer is then returned to the sweep position. The measurement movement algorithm may comprise a machine learning model to perform some or all of the processing performed.

The algorithm may compare the current ultrasound image to a previous ultrasound image or to a reference image. When comparing the current image to a previous image, the algorithm considers two types of motion. The previous image may be one of a set of images of liver-planes. The previous image may be an image obtained earlier in the same scan.. The method for detecting measurement motion may comprise the following steps:

### Case 1: In-Plane Translation

Step 1: The images are compared assuming that the current image is a two-dimensional translation of a previous image. The translation required to obtain the best image match is calculated, outputting a goodness-of-fit metric (e.g. DICE) and best translation shift.

Step 2: If the translation goodness of fit metric is greater than a set threshold, then the transducer is flagged as likely to have been translated.

### Case 2: Rotation

As the liver is not a sphere, rotating the transducer will change the intersection of the transducer plane and the liver volume. This significantly impacts the size and position of the edge liver in the view. Note that the changes are dominantly those edges to the left/right of the transducer, as the edge passing through the rotation point stays nominally fixed. This contrasts with sweep movement along the sweep axis, where the edge of the liver changes slowly in an expected manner.
Step 1: Extract the visible edge(s) of the liver in the images.
Step 2: As a simplest metric, calculate the length of visible edge in each image. Compare the change in edge length against a threshold to determine if the current image is being rotated. The threshold used is preferably set according to the current liver plane detected.
Step 3: A probability of rotation can be output as a metric according to the magnitude of length change divided by the ‘rotation threshold’ value.
Step 4: If the rotation metric is greater than a set threshold, then the transducer is flagged as having been rotated.

The thresholds applied to the different metrics may be adjusted based on previous identified liver planes. A number of previous images may be compared to the current image. Using more than one previous image allows the system to have tolerance of small insignificant changes, such that trends in transducer movement are identified, rather than noisy instantaneous changes. The translation metrics calculated by the movement-measurement algorithm may be averaged over a buffer of previous images. The rotation metrics calculated by the movement-measurement algorithm may also be averaged over a buffer of previous images. If the average translation goodness of fit metric is greater than a set threshold, then the transducer is flagged as likely to have been translated. If the average rotation metric is greater than a set threshold, then the transducer is flagged as having been rotated.

If the system shows in-plane translation then rotation, or significant rotation alone (for a lesion on the sweep axis), then the system must have been in the measurement-movement phase.

If the user adds a new lesion measurement, then the system knows the system must have been in the measurement-movement phase. The algorithm will then determine that the transducer is in the measurement phase even for a low probability of translation and rotation.

When the system is identified as having been changed from sweep to measurement-movement phase, the algorithm can backtrack to the earliest image matching the trend of translation or rotation to identify where the preceding sweep phase ended. This may also be labelled as a possible lesion location.

The measurement movement algorithm may use the following criterions for terminating the measurement movement:

Case 1: A sweep phase liver-plane is detected by the plane detection algorithm. When a liver-plane is detected, the sweep position is reset to the position of the detected liver-plane or the ‘sweep position’.

Case 2: The current image is compared to images recorded prior to the measurement motion phase. The comparison: translation method is reused, as it is likely that the transducer will not be returned to the exact same spot, so a translation tolerance is permitted. When the match between the current image and a prior sweep image is sufficient, allowing for some tolerance in the translation between the images, then the measurement-move phase ends and the sweep phase is resumed. The sweep position of the matching image is set to that of the matched prior image.

In some embodiments, more complex metrics can be used for identifying in-plane translation and rotation states of the transducer or image capturing device. A two-dimensional image from a transducer is formed from two axes, both perpendicular to the sweep axis. One of these axes can be referred to as “up/down”, referring to the length of the body of the patient. The other is “in/out”, referring to the height/depth of the transducer. The in/out axis corresponds to “near/far”. The left/right axis is from the point-of-view of the image, which is the up/down axis. Rotation modifies the distance to the liver edge along the transducer's left-right axis much more than the distance to near-far liver edges directly in front of the transducer. Similarly, as the shape of the current projection of the liver's edge also changes, alternative metrics such as a change in image compactness (perimeter divided by area) can be used. Trends can use non-linear averaging to avoid sporadic noise. In some examples, an arithmetic average may be used. In other embodiments a local median may be used, thus allowing for transducer shake. Each of these metrics may be used in embodiments to decide whether the transducer is in sweep phase or measurement phase.

In some embodiments, the position algorithm determines the position of the lesion in a captured image and identifies the segment of the liver that comprises the lesion. The position algorithm may comprise the use of a trained machine learning model.

Sweep positions can be considered to be positions resulting from movement of the transducer along the sweep axis. The liver planes are detected as the sweep continues, and the sweep position may be defined by the last liver plane detected. e.g. a sweep position could be “at liver plane XYZ” or “after liver plane XZY”. If retrospective positioning is also done, e.g. such as before the first liver plane is detected or for confidence assessment, then a position can also be defined as “before liver plane ABC” as well as “after plane XZY”. The processing for “after” or “before” may be substantially the same, so either works to locate the sweep-axis position the transducer is in. The liver-plane that matches with the scanned image at the position of the lesion, and may be referred to as the ‘current liver-plane’, provides an atlas image that may be used to identify liver segments in a coverage area comprising the sweep plane.

Step 1: If the operator observes a lesion during the sweep, they stop sweep motion at that point. The sweep position is the current/last liver plane seen. In cases where the first liver-plane has not been detected yet, the next detected-liver plane may be used to define the sweep position for lesion detection. The sweep position provides the appropriate atlas image for liver regions.

Step 2: The operator centers the lesion in the current view by panning the view of the ultrasound transducer. After the lesion is measured, this translation movement defines the position of the transducer within the sweep-position's atlas.

Step 3: In order to measure the lesion's long and short axes, the operator rotates the transducer over the lesion and records the appropriate measurements.

Step 4: If the user completed the lesion measurement, then the atlas from step 1 and the position information from step 2 are used to define the liver region. If the first liver plane has yet to be identified, then—a simpler method may be used to define the liver region, such as the top or bottom half of the image or similar variations thereof. In some cases the determination of the liver segment can be delayed until the first liver-plane is identified, at which point, the identified liver-plane is used to provide the atlas image.

The sweep plane position can be used to obtain one axis measurement of the lesion position in the liver. The matched liver plane provides the required atlas image required to identify liver segments in this part of the sweep.

The translation required from the sweep position to the measurement position gives the other two co-ordinates. These are then compared to the current liver plane to identify the liver segment of the lesion.

A current liver plane may be used as an atlas image, with all liver segments visible on that liver plane image annotated.
Liver segments annotated on liver-planes:
   Liver plane image(s) are then used as atlas images such that any position in a matched image can have the equivalent point in the liver plane image identified.
Translation required from the sweep phase centre to the lesion centre.
   Lesion centre is identifiable as the centre of the image when the user begins to rotate the image rather than translate.

### Outputs:

Liver Segment for the Given Lesion

Lesions may be seen between successive plane detections. Each liver lesion may be bounded by two liver-plane detections. Lesions that are seen in only one plane are analysed as previously described in embodiments.

When two bounding planes are detected for a given lesion, the position algorithm can be run for both liver-planes and the results compared. Where the results disagree, this can indicate a result that the operator may need to review. This can be done during the scan, at the time when the lesion is identified, so that the operator still has local context to make a manual intervention.

In some embodiments, the sweep detection algorithm compares a sequence of detected liver-planes to identify whether the sequence comprises a left-to-right scan sweep or a right-to-left scan sweep or it determines that this cannot be derived from the input data. The algorithm may comprise a trained machine learning model.

Automating the liver segment identification can allow operators with skills limited to identifying and measuring lesions to perform the sweep and identify the locations of lesions in addition to measuring the lesions.

Various embodiment provide for automation of the identification of the liver segment for each lesion by:
(a) identifying a sequence of known locations in the liver, and
(b) identifying what kind of ultrasound transducer movement is the operator is currently performing. The transducer may perform one of sweep movement or movement to measure a lesion.

Combining knowledge of sweep location via the sequence of known locations with movements identified as measuring a lesion can enable the liver segments to be automatically identified. This automation can reduces the time required for a sweep and the level of skill required to perform it. The methods according to various embodiments can have a number of benefits for the subject, operator and efficiency of the process in a clinical environment. The methods may reduce, if not remove, the complex series of transducer movements typically used to identify liver segments. The methods may increase the speed of the scan which can be beneficial for both the subject and the operator as well as the output of the system in a clinical environment. The methods may simplify the workflow of the process for an operator so that less experienced operators are aided in the technically challenging and time-consuming task of identifying liver segments. They also reduce the potential for musculoskeletal damage to operator due to stressful movements.

### According to at Least Some Embodiments There Is Provided an Ultrasound Apparatus Comprising processing circuitry configured to:

receive ultrasound data from an ultrasound transducer, wherein the ultrasound transducer is for moving across a region of a patient or other subject to locate a target feature; generate a sequence of images from the ultrasound data, each image representing a view of the subject at a respective position of the transducer; and
determine differences between images in the sequence and use the differences to determine a part of the sequence that corresponds to a sweep motion by the transducer and a part of the sequence that corresponds to a measurement motion by the transducer.

The processing circuitry may be configured to use the differences between images to determine a part of the sequence that corresponds to a translation motion for centring or otherwise positioning the target feature on one on of the images prior to the measurement motion.

The processing circuitry may be configured to assign a location to the target feature based on a position of the transducer during the part of the sequence corresponding to the measurement motion.

The processing circuitry may be configured to process the sequence of ultrasound images to identify at least one anatomical feature in at least some of the images thereby to determine a position of the transducer with respect to the patient or other subject.

The at least one anatomical feature may comprise at least one of a liver edge, blood vessel, a vascular structure, a branch point of a blood vessel or other vascular structure, a part of the liver or a liver segment.

The identifying of the at least one anatomical feature may comprise matching at least one of the images in the sequence to at least one atlas, reference image or other reference data set.

The at least one atlas, reference image or other reference data set may comprise at least one liver plane.

The processing circuitry may be configured to match the images to an ordered series of liver planes.

The measurement motion may comprise at least a rotational motion.

The processing apparatus may be configured to determine at least one of the rotational motion or the translational motion or the alignment motion based on differences between the images in the sequence.

The differences between images may comprise differences in registrations, wherein the registrations are between the images in the sequence and one or more reference images.

The identifying of at least one of the rotational motion or translational motion or alignment motion may comprise comparing a measure of the differences between the images to a threshold.

The sweep motion may comprise a linear or curved motion that is in a different direction to a linear or curved motion that may be included in the measurement motion.

The processing circuitry may be configured to use the differences between the images to determine a direction of motion of the transducer.

The differences between the images may comprise at least one of a difference between shape, size, orientation of at least one feature in the images or a change in spacing or relative size or orientation of a plurality of features in the images.

The apparatus may be such that at least one of:
i) the target feature comprises a lesion or other pathology;
ii) the measurement motion comprises a motion associated with a measurement procedure for measuring a size or other property of the target feature;
ii) the apparatus further comprises the transducer.

The assigning of a location to the target feature may comprise assigning the target feature to a liver segment of a plurality of liver segments arranged in accordance with the Couinaud segmentation or other segmentation scheme.

The processing circuitry may be configured to apply a trained model to the ultrasound data or the images thereby to determine the differences between images and/or to determine the part of the sequence that corresponds to the sweep motion by the transducer and the part of the sequence that corresponds to the measurement motion.

The apparatus may further comprise a user input device and the processing circuitry is configured to perform at least one of the following based on user input received via the user input device:
i) record the start or end of a sweep motion or measurement motion;
ii) confirm or reject an assigned location of the target feature;
iii) accept or reject a candidate target feature;
iv) record measurement data; or
v) provide an output indicating that the transducer has returned to, or providing guidance as to how to return to, a previous sweep position or measurement position thereby to allow resumption of a sweep motion or measurement motion.

According to at least some embodiments there is provided an ultrasound method comprising:
receiving ultrasound data from an ultrasound transducer moving or moved across a region of a patient or other subject to locate a target feature;
generating a sequence of images from the ultrasound data, each image representing a view of the subject at a respective position of the transducer;
determining differences between images in the sequence;
using the differences to determine a part of the sequence that corresponds to a sweep motion by the transducer and a part of the sequence that corresponds to a measurement motion by the transducer.

According to certain embodiments, there is provided a method for automatically identifying the location of a lesion observed from a sequence of 2D ultrasonic images from an ultrasound scan of the liver, where the location is defined according to the Couinaud classification. The method may comprise at least some or all of the following steps:
identifying those images in the sequence that match a known liver plane from a set of known liver planes, where a liver plane is a particular view of identifiable anatomical structures in the liver, and the liver planes may be defined from the viewpoint of a sweep of the liver taken in a left-right (or right-left) sweep direction and may be sufficient to identify all major vascular landmarks and their branching in the liver (including anatomical variants);
identifying from the sequence of images when the ultrasound transducer is:
   i) being moved along the left-right axis of the liver as performed for a standard sweep of the liver or
   ii) being moved to view and measure a lesion in the liver; identifying a translation in the image plane rather than a movement along the left-right liver axis, where the lesion is moved to the centre of the view (which can be zero if the lesion is already centred);
identifying rotation of the imaging plane as a centred-lesion is viewed from a number of angles in order to measure it;
identifying the ‘last sweep image’ from the sequence of images where the ultrasound transducer has been identified as moving along the left-right axis of the liver, just prior to the identification of the transducer being moved to view and measure a lesion;
calculating the translation movement of the UL transducer after the last sweep image to where it is identified as being rotated to measure a lesion in the liver;
identifying the position in the liver using the liver plane identifications and the translation from the last sweep image to the lesion measurement position.

Each liver plane detection image may have regions matching the Couinaud segmentation classifications annotated. The previous liver plane may then be used as an atlas to identify the Couinaud segmentation using the translation co-ordinates determined by the translation required to recenter the lesion image from the last sweep.

The liver plane's Couinaud segmentation atlas may be first non-rigidly deformed to best-match the visible liver anatomy (e.g. liver edges and position of major vessels) observed in the last image detected as a match to the liver plane, before the Couinaud segmentation is determined Translation may be identified by comparing images assuming a 2D translation of a previous image. The translation required to obtain the best image match may be calculated, outputting a goodness-of-fit metric and best translation shift. Where the goodness-of-fit value exceeds a threshold, then the image may be flagged as being a potential translation movement.

A series of sequential images may be flagged as potential translation movements, all images from the first such flagged image may be identified as being due to movement to view and/or measure a lesion in the liver.

Images may be analysed assuming a possible rotation of the ultrasound transducer. The extent of the current imaging plane of the liver due to the transducer position may be measured using one or more suitable metrics. Where the change in the metric exceeds a threshold, then the image may be flagged as being a potential rotation movement.

A series of sequential images may be flagged as potential rotation movements, all images from the first such flagged image may be identified are identified as being due to movement to view and/or measure a lesion in the liver.

The threshold for identifying potential translation may be set according to the previous liver plane detected.

The threshold for identifying potential rotation may be set according to the previous liver plane detected The ultrasound operator may be requested to confirm the Couinaud segmentation or to manually override.

The following liver plane may be used in the same manner as the previous plane. Where the resultant two Couinaud segmentations match, this may be taken as a high confidence result. Where they differ, a low confidence result may be returned.

The ultrasound operator may be requested to confirm the Couinaud segmentation only when a low confidence result is returned.

A feature other than a lesion in the liver may be the feature of interest in some embodiments.

A user-interface of the apparatus may indicate the current Couinaud segmentation(s) available given the previous liver plane detection. This can be done by, for example, any one or more of: text annotations for each potential Couinaud segmentation; a color specific to each potential Couinaud segmentation; areas in a liver-schemic diagram showing each potential Couinaud segmentation; color highlighting of the current ultrasound image showing potential Couinaud segmentations; or a combination of these features.

A user-interface of the apparatus may indicate the Couinaud segmentation that would be identified if the current ultrasound transducer location was considered to be at the centre of a lesion. This can be done by, for example, any one or more of: text annotation for the potential Couinaud segmentation; a color specific to the potential Couinaud segmentation; area in a liver-schemic diagram showing the potential Couinaud segmentation; color highlighting of the current ultrasound image showing the potential Couinaud segmentation; or a combination of these features.

Whilst particular circuitries have been described herein, in alternative embodiments functionality of one or more of these circuitries can be provided by a single processing resource or other component, or functionality provided by a single circuitry can be provided by two or more processing resources or other components in combination. Reference to a single circuitry encompasses multiple components providing the functionality of that circuitry, whether or not such components are remote from one another, and reference to multiple circuitries encompasses a single component providing the functionality of those circuitries.

Whilst certain embodiments are described, these embodiments have been presented by way of example only, and are not intended to limit the scope of the invention. Indeed, the novel methods and systems described herein may be embodied in a variety of other forms. Furthermore, various omissions, substitutions and changes in the form of the methods and systems described herein may be made without departing from the spirit of the invention. The accompanying claims and their equivalents are intended to cover such forms and modifications as would fall within the scope of the invention.

1. An ultrasound apparatus comprising processing circuitry configured to:
receive ultrasound data from an ultrasound transducer, wherein the ultrasound transducer is for moving across a region of a patient or other subject to locate a target feature;
generate a sequence of images from the ultrasound data, each image representing a view of the subject at a respective position of the transducer; and
determine differences between images in the sequence and use the differences to determine a part of the sequence that corresponds to a sweep motion by the transducer and a part of the sequence that corresponds to a measurement motion by the transducer.

2. The apparatus of claim 1, wherein the processing circuitry is configured to use the differences between images to determine a part of the sequence that corresponds to a translation motion for centring or otherwise positioning the target feature on one on of the images prior to the measurement motion.

3. The apparatus of claim 1, wherein the processing circuitry is configured to assign a location to the target feature based on a position of the transducer during the part of the sequence corresponding to the measurement motion.

4. The apparatus of claim 1 wherein the processing apparatus is configured to process the sequence of ultrasound images to identify at least one anatomical feature in at least some of the images thereby to determine a position of the transducer with respect to the patient or other subject.

5. The apparatus of claim 4, wherein the at least one anatomical feature comprises at least one of a liver edge, blood vessel, a vascular structure, a branch point of a blood vessel or other vascular structure, a part of the liver or a liver segment.

6. The apparatus of claim 5, wherein the identifying of the at least one anatomical feature comprises matching at least one of the images in the sequence to at least one atlas, reference image or other reference data set.

7. The apparatus of claim 6, wherein the at least one atlas, reference image or other reference data set comprises at least one liver plane.

8. The apparatus of claim 7, wherein the processing circuitry is configured to match the images to an ordered series of liver planes.

9. The apparatus of claim 1 wherein the measurement motion comprises at least a rotational motion.

10. The apparatus of claim 9 wherein the processing apparatus is configured to determine at least one of the rotational motion or the translational motion or the alignment motion based on differences between the images in the sequence.

11. The apparatus of claim 10 wherein the differences between images comprise differences in registrations, wherein the registrations are between the images in the sequence and one or more reference images.

12. The apparatus of claim 10, wherein the identifying of at least one of the rotational motion or translational motion or alignment motion comprises comparing a measure of the differences between the images to a threshold.

13. The apparatus of claim 9 wherein the sweep motion comprises a linear or curved motion that is in a different direction to a linear or curved motion that may be included in the measurement motion.

14. The apparatus of claim 1 wherein the processing circuitry is configured to use the differences between the images to determine a direction of motion of the transducer.

15. The apparatus of claim 1, wherein the differences between the images comprises at least one of a difference between shape, size, orientation of at least one feature in the images or a change in spacing or relative size or orientation of a plurality of features in the images.

16. The apparatus of claim 1, wherein at least one of:
i) the target feature comprises a lesion or other pathology;
ii) the measurement motion comprises a motion associated with a measurement procedure for measuring a size or other property of the target feature;
ii) the apparatus further comprises the transducer.

17. The apparatus of claim 2, wherein the assigning of a location to the target feature comprises assigning the target feature to a liver segment of a plurality of liver segments arranged in accordance with the Couinard segmentation or other segmentation scheme.

18. The apparatus of claim 1, wherein the processing circuitry is configured to apply a trained model to the ultrasound data or the images thereby to determine the differences between images and/or to determine the part of the sequence that corresponds to the sweep motion by the transducer and the part of the sequence that corresponds to the measurement motion.

19. The apparatus of claim 1, further comprising a user input device and the processing circuitry is configured to perform at least one of the following based on user input received via the user input device:
i) record the start or end of a sweep motion or measurement motion;
ii) confirm or reject an assigned location of the target feature;
iii) accept or reject a candidate target feature;
iv) record measurement data; or
v) provide an output indicating that the transducer has returned to, or providing guidance as to how to return to, a previous sweep position or measurement position thereby to allow resumption of a sweep motion or measurement motion.

20. An ultrasound method comprising:
receiving ultrasound data from an ultrasound transducer moving or moved across a region of a patient or other subject to locate a target feature;
generating a sequence of images from the ultrasound data, each image representing a view of the subject at a respective position of the transducer;
determining differences between images in the sequence;
using the differences to determine a part of the sequence that corresponds to a sweep motion by the transducer and a part of the sequence that corresponds to a measurement motion by the transducer.
